(19) United States
(12) Patent Application Publication
(10) Pub. No.: US 2010/0009836 A1
(43) Pub. Date: Jan. 14, 2010

(54) Zinc Containing Glasses And Enamels

(75) Inventor: George E. Sakoske, Washington, PA (US)

Correspondence Address: RANKIN, HILL & CLARK LLP, 23755 Lorain Road - Suite 200, North Olmsted, OH, 44070-2224, US

(73) Assignee: FERRO CORPORATION, Cleveland, OH (US)

(21) Appl. No.: 12/170,530

(22) Filed: Jul. 10, 2008

(51) Int. Cl. C03C 8/00; B05D 3/02

(52) U.S. Cl. 501/14; 427/376.2

(57) ABSTRACT

This invention relates to lead free, cadmium free, bismuth free low melting high durability glass and enamel compositions. The compositions comprise silica, zinc, titanium, and boron oxide based glass frits. The resulting compositions can be used to decorate and protect automotive, beverage, architectural, pharmaceutical and other glass substrates.

### BACKGROUND OF THE INVENTION

1. Field of Invention

This invention relates to low-firing, high durability glass and enamel compositions. In particular, the invention relates to glass frit compositions, and the glasses, ceramics and enamels made therefrom, which include ZnO, SiO₂, B₂O₃ and TiO₂. The glasses have good acid resistance, low CTE (<100×10⁻⁷) and relatively low firing temperatures (<1100° F.). All of this is achieved without the use of lead or bismuth.

2. Description of Related Art

Glass enamel compositions are well known in the art. One aim of conventional glass and enamel compositions is the achievement of a low firing, high durability glass and enamel having a low coefficient of thermal expansion (CTE). However, such glasses typically require the use of substantial amounts of relatively expensive Bi₂O₃.

Partially crystallizing glass enamel compositions that fuse at relatively low temperatures are used, for example, to form opaque dark-colored enamel bands on the outer edges of sections of automotive glass such as windshields and side and rear windows. These opaque dark-colored enamel bands, which typically vary in width from about 1.5 cm to about 15.0 cm, greatly enhance the aesthetic appearance of the sections of glass upon which they are applied and also block the transmission of sunlight through the glass to protect underlying adhesives from degradation by ultraviolet radiation. Moreover, these opaque colored enamel bands preferably have the ability to conceal silver-containing buss bars and wiring connections of rear glass defrosting systems from view from the outside of the vehicle.

Specially formulated glass enamel compositions can be applied to planar sections of glass and fired to form opaque dark-colored enamel bands at the same time as the bending or forming operations were performed on the section of glass. Such glass enamel compositions can fuse and partially crystallize at the temperature at which a section of glass would be preheated preparatory to a bending or forming operation. It is believed that the partial crystallization of the enamel forms a dense, hard, protective layer that prevents the enamel from sticking to the press or vacuum head during the glass bending and transporting operations.

An example of a high durability glass and enamel compositions is a partially crystallizing lead-free and cadmium-free glass and enamel compositions including substantial amounts of SiO₂, TiO₂, Bi₂O₃, and ZnO. U.S. Pat. No. 6,936,556 to Sridharan is representative of this type. The partially crystallizing glass and enamel compositions form residual glass and non-silicate crystals upon firing. A predominant portion of the non-silicate crystals are titanate crystals, typically bismuth titanate or zinc titanate.

Although improvements have been made in recent years, the chemical durability of known lead-free and cadmium-free glass enamel systems used in tableware, decorative ware, and automotive glass applications has been less than desired. Further, the presence of bismuth, an increasingly expensive metal, has been required in such formulations as a lead replacement. Therefore, a need exists for lead-free and cadmium-free (and preferably bismuth-free) enamel compositions that exhibit excellent chemical durability to acids, water, and alkalis. Such enamel compositions must be able to fuse and preferably, partially crystallize at temperatures at which sections of glass are preheated preparatory to forming operations so as not to stick to press or vacuum heads. Moreover, such enamel compositions should be effective in blocking ultraviolet radiation and in retarding the migration of silver and subsequent showing from overprinted buss bars and wiring corrections of rear glass defrosting systems.

### BRIEF SUMMARY OF THE INVENTION

The invention relates to a range of low firing, high durability glasses, glass frits, and glass enamel compositions. Automotive designs employ a black glass-ceramic enamel obscuration band around the periphery of glass windshields to hide unevenness and protect the underlying adhesive from ultraviolet degradation. Architectural, appliance, and container/dishware glass applications often include glass ceramic materials for decorative purposes. Conventional low firing, high durability enamel systems require the use of expensive bismuth borosilicate glass frits. The invention relates to a range of glass frits including the oxides of zinc, boron, titanium and silicon. The glass and enamel compositions fired therefrom will pass high durability acid testing, including, for example, performance of more than six hours in 0.1 N H₂SO₄ at 80° C. In addition, crystalline seed materials including, for example zinc borates, zinc titanates, aluminum silicates and others are compatible with the enamel composition herein, and can yield anti-stick properties advantageous in press-bend forming operations such as those used in the automotive glass industry.

In particular, the invention provides a glass and enamel compositions comprising, prior to firing: (a) 38-60 wt % SiO₂, (b) 5.1-22.9 wt % B₂O₃, (c) 8.1-18 wt % TiO₂, (d) 0.1-14.9 wt % ZnO, (e) 0.1-4.5 wt % Li₂O (f) 0.1-18 wt % K₂O, and (g) 1-7 wt % F.

In another embodiment, the invention involves a method of decorating a substrate comprising (a) applying to a glass substrate a coating of an enamel composition comprising, prior to firing: (i) 38-60 wt % SiO₂, (ii) 5.1-22.9 wt % B₂O₃, (iii) 8.1-18 wt % TiO₂, (iv) 0.1-14.9 wt % ZnO, (v) 0.1-3.5 wt % Li₂O (vi) 0.1-18 wt % K₂O, and (vii)1-7 wt % F, and (b) firing the substrate and coating at a temperature sufficient to flow the enamel composition to cause the enamel composition to adhere to the substrate.

Finally, the invention includes an automotive glass bearing a fired coating, the fired coating comprising, prior to firing, (a) 38-60 wt % SiO₂, (b) 5.1-22.9 wt % B₂O₃, (c) 8.1-18 wt % TiO₂, (d) 0.1-14.9 wt % ZnO, (e) 0.1-4.5 wt % Li₂O (f) 0.1-18 wt % K₂O, and (g) 1-7 wt % F.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### DETAILED DESCRIPTION OF THE INVENTION

A glass and enamel compositions of the invention comprises a combination of the oxides of zinc, boron, silicon and titanium, as well as fluoride ion.

In particular, the invention provides a glass and enamel compositions comprising, prior to firing: (a) 38-60 wt % SiO₂, (b) 5.1-22.9 wt % B₂O₃, (c) 8.1-18 wt % TiO₂, (d) 0.1-14.9 wt % ZnO, (e) 0.1-4.5 wt % Li₂O (f) 0.1-18 wt % K₂O, and (g) 1-7 wt % F.

In another embodiment, the invention involves a method of decorating a substrate comprising (a) applying to a glass substrate a coating of an enamel composition comprising, prior to firing: (i) 38-60 wt % SiO₂, (ii) 5.1-22.9 wt % B₂O₃, (iii) 8.1-18 wt % TiO₂, (iv) 0.1-14.9 wt % ZnO, (v) 0.1-4.5 wt % Li₂O (vi) 0.1-18 wt % K₂O, and (vii)1-7 wt % F, and (b) firing the substrate and coating at a temperature sufficient to flow the enamel composition to cause the enamel composition to adhere to the substrate.

Finally, the invention includes an automotive glass bearing a fired coating, the fired coating comprising, prior to firing, (a) 38-60 wt % SiO₂, (b) 5.1-22.9 wt % B₂O₃, (c) 8.1-18 wt % TiO₂, (d) 0.1-14.9 wt % ZnO, (e) 0.1-4.5 wt % Li₂O (f) 0.1-18 wt % K₂O, and (g) 1-7 wt % F.

The components of the inventive compositions, articles and methods are detailed hereinbelow. Compositional percentages are by weight. All percentages, temperatures, times, and ranges of other values are presumed to be accompanied by the modifier “about.”

All compositional percentages are by weight and are given for a blend prior to firing. Details on each ingredient follow.

Glass Component. The principal glass and enamel compositions herein include SiO₂, B₂O₃, TiO₂, ZnO, Li₂O, K₂O and F₂. In particular, broad and preferred embodiments of the glass and enamel compositions herein are detailed below. The glass frit compositions herein include SiO₂: broadly 38-60%, preferably 41-51% and more preferably 45-50%; B₂O₃: broadly 5.1-22.9%; preferably 6-17% and more preferably 8-15%; TiO₂: broadly 8.1-18 wt %, preferably 8.5-13% and more preferably 11-15%; ZnO: broadly 0.1-14.9%; preferably 5.1-13%; more preferably 8-12%; Li₂O: broadly 0.1-4.5%, preferably 0.1-3%, more preferably 0.5-2.5%; K₂O: broadly 0.1-18%; preferably 1-7.9%, more preferably 1.7-4%; and F: broadly 1-7%, preferably 1.5-6%, more preferably 2-5%.

Other embodiments are possible, using, for example, a combination of ranges of oxides indicated as “broad,” “preferred” and “more preferred” in various combinations, so long as such combination can add up to 100 wt %. For example, 38-60 wt % SiO₂; 8-15 wt % B₂O₃; 8.5-13 wt % TiO₂ 8-12 wt % ZnO, 0.1-4.5 wt % Li₂O, 0.1-18 wt % K₂O, and 1-7 wt % F. Another possible embodiment is 41-51 wt % SiO₂, 5.1-22.9 wt % B₂O₃, 11-15 wt % TiO₂, 5.1-13 wt % ZnO, 0.1-3 wt % Li₂O, 1-7.9 wt % K₂O and 1-7 wt % F. Other combinations are possible.

Secondary, optional oxides may be added to frits according to the formulations in the preceding two paragraphs in the following weight percentages: Al₂O₃, 0.1-1.9%, preferably 0.1-0.95, more preferably 0.1-0.8%; ZrO₂: 0.1-4%, preferably 0.1-1.5%, more preferably 0.1-0.8%; and Na₂O: 0.1-13%, preferably 5-12%, more preferably 8-11%.

Additional oxides can be added to any previously described embodiment, singly, or in any combination, up to the noted weight percentage: Cs₂O 2%; MgO: 5%; CeO₂: 5%; MnO: 10%; CuO: 5%; NiO 5%; SnO: 10%; P₂O₅: 5%; V₂O₅: 10%; La₂O₃: 5%; Pr₂O₃: 5%; In₂O₃: 5%; Fe₂O₃: 10%; Cr₂O₃: 5%; CoO: 5%; Nb₂O₅: 4; WO₃: 4; MoO₃: 4. In a preferred embodiment, the glass and enamel compositions herein further comprise at least one of the noted additional oxides where the range has a lower bound of 0.1%. The glass and enamel compositions herein may also include 0.1-4.9% Bi₂O₃, but this is not preferred.

As can be seen above, the composition of the glass frits useful in this invention can be adapted over a broad range of oxide compositions. Glasses may be formulated according to the principal glass and enamel compositions above, together with, optionally one or more secondary or additional oxides. The glass and enamel compositions herein typically contain low amounts of PbO, CdO and Bi₂O₃, i.e., less than 5 wt % of each, preferably less than 1 wt % of each, more preferably less than 0.5 wt % of each, and even more preferably, less than 0.1 wt % of each. Most preferably, the glass and enamel compositions herein are devoid of intentionally added PbO, CdO, and Bi₂O₃. However, certain embodiments not involving food or beverage storage may intentionally include oxides of lead or oxides of cadmium or oxides of bismuth, or any combination thereof.

Sulfide glass frits are glass frits that contain a metal sulfide component. Certain embodiments of the invention include sulfide ions provided by elemental sulfur or metallic sulfides. Exemplary sulfide glass frits are disclosed in U.S. Pat. No. 5,350,718 to Antequil et al., which is hereby incorporated by reference. Exemplary sulfides in such frits include ZnS, MnS, FeS, CoS, NiS, Cu₂S, CdS, Sb₂S₃ and Bi₂S₃. In particular, the glass and enamel compositions herein may include 0-4 wt % sulfur, or a sufficient amount of a metallic sulfide so as to provide 0-4 wt % sulfur to a glass and enamel compositions, prior to firing.

A glass component containing both oxide and sulfide frits are also envisioned. The glass frits useful herein have melting points in the range of about 1000° F. to 1400° F., or any intermediate temperature such as 1030° F., 1040° F., 1050° F., 1060° F., 1080° F., 1110° F., 1150° F., 1190° F., 1200° F., 1210° F., 1250° F., 1275° F., 1300° F., various of the frits may be effectively fired at those temperatures. Preferably, the glass frits herein can be fired at 1000-1250° F., more preferably at 1020-1200° F., still more preferably at about 1030-1150° F., and most preferably at about 1040-1100° F.

Generally, the glass frits are formed in a known manner, for example, blending the starting materials (oxides and/or sulfides) and melting together at a temperature of about 1000 to about 1400° C. (about 1830 to about 2550° F.) for about 45 to about 75 minutes to form a molten glass having the desired composition. The molten glass formed can then be suddenly cooled in a known manner (e.g., water quenched) to form a frit. The frit can then be ground using conventional milling techniques to a fine particle size, from about 1 to about 8 microns, preferably 2 to about 6 microns, and more preferably about 3 to about 5 microns.

Crystalline Material. Crystalline materials may be included along with the frit compositions herein to promote crystallization. Crystalline materials useful herein include zinc silicates, zinc borates, zinc titanates, silicon zirconates, aluminum silicates, calcium silicates, and combinations thereof. The crystalline materials may include, without limitation, Zn₂SiO₄, 2ZnO.3TiO₂, ZnTiO₃, ZnO.B₂O₃, 3ZnO.B₂O₃, 5ZnO.2B₂O₃, and Al₂SiO₅. The Ruderer U.S. Pat. No. 5,153,150 and Sakoske U.S. Pat. No. 5,714,420 patents noted hereinabove provide further information on crystalline materials. Preferred crystalline materials include zinc silicates such as Zn₂SiO₄ and zinc borosilicates such as ZnO.B₂O₃. Specific examples of seed materials used herein include product numbers 2077 (bismuth silicate seed material) and 2099 (zinc silicate seed material) manufactured by Ferro Glass and Color Corporation.

Organic Vehicle. When applied by procedures requiring one, such as screen printing, the foregoing solid ingredients may be combined with an organic vehicle to form a green glass enamel composition, which is a paste. The green paste in general contains 60 to 90% solids as above described and 10 to 40% of an organic vehicle. The viscosity of the paste is adjusted so that it can be screen-printed, roll coated, sprayed, or otherwise applied in a desired manner onto the desired substrate.

The organic vehicle comprises a binder and a solvent, which are selected based on the intended application. It is essential that the vehicle adequately suspend the particulates (i.e., frit, crystalline material) and burn off completely upon firing. In particular, binders including methyl cellulose, ethyl cellulose, and hydroxypropyl cellulose, and combinations thereof, may be used. Suitable solvents include propylene glycol, diethylene glycol butyl ether; 2,2,4-trimethyl pentanediol monoisobutyrate (Texanol™); alpha-terpineol; beta-terpineol; gamma terpineol; tridecyl alcohol; diethylene glycol ethyl ether (Carbitol™), diethylene glycol butyl ether (Butyl Carbitol™); pine oils, vegetable oils, mineral oils, low molecular weight petroleum fractions, tridecyl alcohols, and synthetic or natural resins and blends thereof. Surfactants and/or other film forming modifiers can also be included. The solvent and binder may be present in a weight ratio of about 50:1 to about 20:1. The preferred vehicle is a combination of Butyl Carbitol™ (diethylene glycol monobutyl ether) and ethyl cellulose in a weight ratio of about 200:1 to 20:1, 50:1 to about 20:1, more preferably about 40:1 to about 25:1.

In general, the enamel pastes are viscous in nature, with the viscosity depending upon the application method to be employed and end use. For purposes of screen-printing, viscosities ranging from 10,000 to 80,000, preferably 15,000 to 35,000 centipoise, and more preferably 18,000 to 28,000 centipoise at 20° C., as determined on a Brookfield Viscometer, #29 spindle at 10 rpm, are appropriate.

Pigments. In certain embodiments, the glass frit can be combined with a mixed metal oxide pigment. When used, such pigments generally constitute no greater than about 30 wt %, and preferably no greater than about 25 wt %, of the glass enamel compositions herein, depending upon the range of color, gloss, and opacity (i.e., transmittance) desired.

Keeping in mind the general preference for completely lead-free, cadmium-free, and bismuth-free compositions for food and beverages, useful pigments may come from several of the major classifications of complex inorganic pigments, including corundum-hematite, olivine, priderite, pyrochlore, rutile, spinel, and spinel, though other categories such as baddeleyite, borate, garnet, periclase, phenacite, phosphate, sphene and zircon may be suitable in certain applications. Oxides of the metals cobalt, chromium, manganese, praseodymium, iron, nickel, and copper are often useful. In particular, specific pigments include cobalt silicate blue olivine Co₂SiO₄; nickel barium titanium primrose priderite 2NiO:3BaO:17TiO₂; nickel antimony titanium yellow rutile (Ti,Ni,Nb)O₂; nickel niobium titanium yellow rutile (Ti,Ni,Nb)O₂; nickel tungsten yellow rutile (Ti,Ni,W)O₂; chrome antimony titanium buff (Ti,Cr,Sb)O₂; chrome niobium titanium buff rutile (Ti,Cr,Nb)O₂; chrome tungsten titanium buff rutile (Ti,Cr,W)O₂; manganese antimony titanium buff rutile (Ti,Mn,Sb)O₂; titanium vanadium grey rutile (Ti,V,Sb)O₂; manganese chrome antimony titanium brown rutile (Ti,Mn,Cr,Sb)O₂; manganese niobium titanium brown rutile (Ti,Mn,Nb)O₂; cobalt aluminate blue spinel CoAl₂O₄; zinc chrome cobalt aluminum spinel (Zn,Co)(Cr,Al)₂O₄; cobalt chromate blue-green spinel CoCr₂O₄; cobalt titanate green spinel Co₂TiO₄; iron chromite brown spinel Fe(Fe,Cr)₂O₄; iron titanium brown spinel Fe₂TiO₄; nickel ferrite brown spinel NiFe₂O₄; zinc ferrite brown spinel (Zn,Fe)Fe₂O₄; zinc iron chromite brown spinel (Zn,Fe)(Fe,Cr)₂O₄; copper chromite black spinel CuCr₂O₄; iron cobalt chromite black spinel (Co,Fe)(Fe,Cr)₂O₄; chrome iron manganese brown spinel (Fe,Mn)(Cr,Fe)₂O₄; chrome iron nickel black spinel (Ni,Fe)(Cr,Fe)₂O₄; and chrome manganese zinc brown spinel (Zn,Mn)(Cr₂O₄). Only in applications where lead is permitted (i.e., other than food or beverage containers, tableware, etc.), lead antimonite yellow pyrochlore (Pb₂Sb₂O₇) or other lead-containing pigments may be used. Commercially available examples of suitable pigments are available from Ferro Glass and Color Corporation, such as 2991 pigment (copper chromite black), 2980 pigment (cobalt chromium iron black), 2987 pigment (nickel manganese iron chromium black), and 0-1776 pigment (black). Pigments free from Co, Cu, Cr, Ni and the like such a 10201 black (bismuth manganate) would also be suitable.

Especially preferred are pigments having the following Ferro Corporation part numbers and formulas: K393 (CuCrMn), V792(NiMnCrFe), 2503(CdSeS), 2336(CoAl), and 2501(CdSeS).

Properties. The glass articles herein are coated in order to impart desired properties to the article. The properties of acid resistance, heavy metal release, color, gloss, and light transmittance, characterize the final finished products are detailed hereinbelow.

Acid Resistance. The glass and enamel compositions herein, and the fired glass, ceramic, and enamel coatings obtained by the firing thereof are often used in harsh environments, including, for example, automotive or architectural glass, institutional table ware, and others.

Heavy Metal Release. Because the inventive glass and enamel compositions herein may be used to decorate glassware for preparing, serving, and storing food, it is important that such compositions contain extremely low concentrations of toxic heavy metals, such as lead and cadmium. Further, in the in the inevitable event that the glass and enamel compositions contains a small portion of such toxic metals, it is important that the glass and enamel compositions do not release the heavy metals, or do so only in minute concentrations. Foe example, it is an advantage of the glass and enamel compositions herein release less than 100 ppm of heavy metals of any kind when subjected to a strong detergent attack as set forth in DTM 77, described hereinbelow. It is more preferred that the glass and enamel compositions release less than 75 ppm, and even more preferred when less than 50 ppm is released. It is still more preferred that less than 25 ppm be released.

Dispersing Surfactant. A dispersing surfactant assists in pigment wetting, when an insoluble particulate inorganic pigment is used. A dispersing surfactant typically contains a block copolymer with pigment affinic groups. For example, surfactants sold under the Disperbyk® and Byk® trademarks by Byk Chemie of Wesel, Germany, such as Disperbyk 162 and 163, which are solutions of high molecular weight block copolymers with pigment affinic groups, and a blend of solvents (xylene, butylacetate and methoxypropylacetate). Disperbyk 162 has these solvents in a 3/1/1 ratio, while the ratio in Disperbyk 163 is 4/2/5. Disperbyk 140 is a solution of alkyl-ammonium salt of an acidic polymer in a methoxypropylacetate solvent.

Rheological Modifier. A rheological modifier is used to adjust the viscosity of the green pigment package composition. A variety of rheological modifiers may be used, including those sold under the Byk®, Disperplast®, and Viscobyk® trademarks, available from Byk Chemie. They include, for example, the BYK 400 series, such as BYK 411 and BYK 420, (modified urea solutions); the BYK W-900 series, (pigment wetting and dispersing additives); the Disperplast series, (pigment wetting and dispersing additives for plastisols and organosols); and the Viscobyk series, (viscosity depressants for plastisols and organosols).

Flow aid. A flow aid is an additive used to control the viscosity and rheology of a pigment composition, which affects the flow properties of liquid systems in a controlled and predictable way. Rheology modifiers are generally considered as being either pseudoplastic or thixotropic in nature. Suitable surfactants herein include those sold commercially under the Additol®, Multiflow®, and Modaflow® trademarks by UCB Surface Specialties of Smyrna, Georgia. For example, Additol VXW 6388, Additol VXW 6360, Additol VXL 4930, Additol XL 425, Additol XW 395, Modaflow AQ 3000, Modaflow AQ 3025, Modaflow Resin, and Multiflow Resin.

Adhesion promoter. Adhesion promoting polymers are used to improve the compatibility between a polymer and a filler. Suitable adhesion promoters include those sold by GE Silicones of Wilton, Connecticut under the Silquest®, CoatOSil®, NXT®, XL-Pearl™ and Silcat® trademarks. Examples include the following product numbers, sold under the Silquest® trademark: A1101,A1102,A1126,A1128,A1130,A1230,A1310,A162,A174,A178,A187, A2120. For example, Silquest A-187 is (3-glycidoxypropyl)trimethoxysilane, which is an epoxysilane adhesion promoter. The inventors herein have found that aromatic epoxies crosslinked with amines or amides produced unacceptable results. Silanes sold by Degussa AG of Düsseldorf, Germany, under the Dynasylan® trademark are also suitable. Most preferred herein is Silquest A187.

Stabilizers. Light or UV stabilizers are classified according to their mode of action: UV blockers—that act by shielding the polymer from ultraviolet light; or hindered amine light stabilizers (HALS)—that act by scavenging the radical intermediates formed in the photo-oxidation process. The compositions of the invention comprise about 0.1 to about 2 wt % of a light stabilizer, preferably about 0.5 to about 1.5%, and further comprise about 0.1 to about 4 wt % of a UV blocker, preferably about 1 to about 3%.

Light stabilizers and UV blockers sold under the Irgafos®, Irganox®, Irgastab®, Uvitex®, and Tinuvin® trademarks by from Ciba Specialty Chemicals, Tarrytown, N.Y., may be used, including product numbers 292 HP, 384-2, 400, 405, 41 IL, 5050, 5055, 5060, 5011, all using the Tinuvin trademark. Suitable UV blocking agents include Norbloc 7966 (2-(2′hydroxy-5′ methacryloxyethylphenyl)-2H-benzotriazole); Tinuvin 123 (bis-(2,2,6,6-tetramethyl-1-(octyloxy)-4-piperidinyl)ester); Tinuvin 99 (3-(2H-benzotriazole-2-yl) 5-(1,1-dimethyl ethyl)-4-hydroxybenzenepropanoic acid, C7-9-branched alkyl esters) Tinuvin 171 (2-(2H-benzotriazol-2-yl)-6-dodecyl-4-methyl-phenol). Products sold under the Norbloc® trademark are available from Janssen Pharmaceutica of Beerse, Belgium.

Suitable hindered amine light stabilizers (HALS) are sold by the Clariant Corporation, Charlotte, N.C., under the Hostavin® trademark, including Hostavin 845, Hostavin N20, Hostavin N24, Hostavin N30, Hostavin N391, Hostavin PR31, Hostavin ARO8, and Hostavin PR25. HALS are extremely efficient stabilizers against light-induced degradation of most polymers. They do not absorb UV radiation, but act to inhibit degradation of the polymer, thus extending its durability. Significant levels of stabilization are achieved at relatively low concentrations. The high efficiency and longevity of HALS are due to a cyclic process wherein the HALS are regenerated rather than consumed during the stabilization process. They also protect polymers from thermal degradation and can be used as thermal stabilizers.

Examples. The following compositions represent exemplary embodiments of the invention. They are presented to explain the invention in more detail, and do not limit the invention. High durability glass and enamel compositions according to the present invention are given in Table 1, columns 3-9. Conventional zinc borosilicate frits are given in columns 1 and 2 for comparative purposes. The thermal expansion coefficient was determined from room temperature to 300° C. using an Orton model 1000R dilatometer. The glass transition temperature is Tg and the dilatometric softening point is Td. The firing temperature determination is described hereinabove. The “firing temperature” is the temperature where the frit particles begin to melt and sinter together upon heating. The room temperature chemical durabilities were determined as described hereinabove for 4% Acetic acid, 10% Citric acid, and 10% hydrochloric acid solutions.

Heavy Metal (cadmium) release of selected enamels in Table 1 is also presented. Sample automotive windshield enamels were also made using these compositions as presented in Table 2. The paste ratio is the weight ratio of solid constituents (glass frits, pigments, metals) to the organic vehicle. The minimum fire of the enamel is determined as described below. The acid test using 0.1N H2S04 at 80° C. results are reported in hours, and the wet through method was used to determine point of failure as described below. This test is commonly called the Toyota test. Conventional zinc-based enamels have not been able to survive more than 4 hours of exposure to 0.1N H₂SO₄ at 80° C.

TABLE 1
Frit formulations in wt %, firing temperatures, data on acid resistance and
heavy metal release.

| | Prior art | Prior art | | | | | | | |
|---|---|---|---|---|---|---|---|---|---|
| | ZnBSi | ZnBSi | | | | | | | |
| Formula | frit 1 | frit 2 | Frit A | Frit B | Frit C | Frit D | Frit E | Frit F | Frit G |
| Oxide | | | | | | | | | |
| Nb₂O₅ | 0.00 | 0.00 | 0.00 | 0.00 | 0.00 | 0.00 | 0.00 | 0.00 | 0.00 |
| CeO₂ | 0.00 | 0.00 | 0.00 | 0.00 | 0.00 | 0.00 | 0.00 | 0.00 | 0.00 |
| SiO₂ | 20.52 | 20.31 | 38.82 | 43.99 | 43.50 | 41.15 | 38.94 | 44.24 | 40.03 |
| TiO₂ | 0.00 | 1.64 | 7.65 | 9.30 | 9.19 | 8.70 | 12.13 | 9.35 | 12.47 |
| ZrO₂ | 1.15 | 7.93 | 0.00 | 0.66 | 0.65 | 0.62 | 0.58 | 0.66 | 0.60 |
| Al₂O₃ | 3.26 | 1.64 | 0.00 | 0.65 | 0.64 | 0.60 | 0.57 | 0.65 | 0.59 |
| B₂O₃ | 30.09 | 27.17 | 9.69 | 14.06 | 13.90 | 13.16 | 12.45 | 14.14 | 12.80 |
| Bi₂O₃ | 0.00 | 0.00 | 0.00 | 0.00 | 0.00 | 0.00 | 1.48 | 0.00 | 0.00 |
| S03*.37 | 0.00 | 0.00 | 0.00 | 0.00 | 1.12 | 1.12 | 1.06 | 0.00 | 0.00 |
| CaO | 0.00 | 5.39 | 0.00 | 0.00 | 0.00 | 0.00 | 0.00 | 0.00 | 0.00 |
| PbO | 0.00 | 0.00 | 0.00 | 0.00 | 0.00 | 0.00 | 0.00 | 0.00 | 0.00 |
| ZnO | 33.37 | 24.63 | 34.38 | 10.86 | 10.74 | 10.36 | 9.81 | 10.93 | 9.89 |
| K₂O | 0.00 | 0.00 | 6.06 | 2.30 | 2.28 | 17.19 | 16.27 | 0.65 | 16.73 |
| Li₂O | 0.00 | 0.00 | 1.61 | 1.91 | 1.88 | 1.78 | 1.69 | 1.92 | 1.73 |
| Na₂O | 11.61 | 10.26 | 1.80 | 10.58 | 10.46 | 0.00 | 0.00 | 11.73 | 0.00 |
| F₂ | 0.00 | 1.02 | 0.00 | 5.69 | 5.63 | 5.32 | 5.03 | 5.72 | 5.17 |
| TEC × 10⁻⁷ in/in | 75.0 | 80.0 | 69.0 | 87.3 | 91.0 | 81.0 | 86.0 | 85.9 | 93.0 |
| ° C. | | | | | | | | | |
| Tg ° C. | 476 | — | 485 | 425 | 436 | 480 | 458 | 423 | 440 |
| Td ° C. | 520 | — | 534 | 475 | 495 | 530 | 515 | 491 | 496 |
| Fire Temp | 1050 | 1110 | 1110 | 1040 | 1050 | 1100 | 1060 | 1035 | 1030 |
| ° F. | | | | | | | | | |
| 4% Acetic | 4.5 | — | 1 | 2 | 3 | 1 | 1 | 2 | 1 |
| 10% Citric | 6 | 5 | 1 | 4 | 3 | 1 | 2 | 4 | 4 |
| 10% HCl | — | — | 4 | 4 | 1 | 1 | 1 | 4 | 4 |
| HMR [Cd] | removed | 74.0 | 200.0 | 3.1 | — | — | — | 3.7 | 3.0 |
| PPM | | | | | | | | | |

TABLE 2
Enamel formulations in wt %, firing data, and acid resistance performance
data for pastes made with selected frits from table 1.

| | Prior Art | Prior Art | | | | | |
|---|---|---|---|---|---|---|---|
| Glass Used | Enamel 1 | Enamel 2 | Enamel A | Enamel B | Enamel C | Enamel D | Enamel E |
| Prior Art 1 | 75.00 | | | | | | |
| Prior Art 1 | | 75.00 | | | | | |
| Glass A | | | 75.00 | | | | |
| Glass B | | | | 75.00 | | | |
| Glass C | | | | | 73.70 | | |
| Glass D | | | | | | 74.70 | |
| Glass E | | | | | | | 74.70 |
| 2099 | 3.40 | 3.40 | 3.40 | 3.40 | 5.00 | 3.00 | 3.00 |
| 2077 | | | | | | 1.00 | 1.00 |
| K393 | 20.00 | 20.00 | 20.00 | 20.00 | | | |
| O-1776B | | | | | 19.00 | 19.00 | 19.00 |
| V792 | | | | | 2.30 | 2.30 | 2.30 |
| Si Metal | 1.60 | 1.60 | 1.60 | 1.60 | | | |
| | 100.0 | 100.0 | 100.0 | 100.0 | 100.0 | 100.0 | 100.0 |
| MIN FIRE ° F. | 1100 | 1110 | 1170 | 1120 | 1150 | 1180 | 1130 |
| Paste Ratio | 4.4 | 4.2 | 3.75 | 4.0 | 3.7 | 3.7 | 3.7 |
| 4% Acetic acid | 6 | 5 | 3 | 2 | 1 | 1 | 1 |
| 10% Citric acid | 7 | 7 | 4 | 3 | 2 | 1 | 1 |
| 10% HCl acid | 6 | 6 | 4 | 3 | 3 | 1 | 3 |
| 0.1 N H₂SO₄ - 80° C. | <1 | <1 | 1-2 | 34-37 | 50-58 | 45-49 | 41-45 |
| (hours) | | | | | | | |

The testing procedures used herein are as follows. Firing Temperature Estimate DTM 59: A screen printable paste is made by blending 4 g±0.1 grams of test frit with pine oil. After a ten-minute pre-heat at 800° F., the trials are then rapidly transferred to a second furnace at a temperature below the expected firing temperature for the frit for 15 minutes. After 15 minutes in the second furnace, the trials are removed and cooled. This cycle is repeated (at higher temperatures) until the printed frit particles become sintered together and cannot be scratched away. Once the “firing temperature” has been determined, an underfire of 10° F. below the “firing temperature” is made for confirmation.

Acid Test Resistance to 10% Citric Acid at Room Temperature, ASTM C-724-91. A visual assessment of the resistance of a glass enamel or frit coating to 10% citric acid at room temperature is made of any residual stain after exposure to the acid solution. The same test is conducted with respect to a 4 wt % solution of acetic acid at room temperature for a one-minute exposure, and a 10 wt % solution of hydrochloric acid at room temperature for a ten-minute exposure.

Heavy Metal Release. Standard test samples are formulated, fired, and aged. The trials are placed in a 4000 cc stainless steel beaker containing a solution consisting of: 2000 cc distilled water and 6 grams of Super Soilax® detergent. During the detergent “aging” exposure prior to HMR testing, the entire trial must be submersed in the solution. The beaker with fired trials is then placed in a constant temperature water bath at 95° C. for 24 hours. After the trials have been exposed to the heated solution for 24 hours, the beaker is removed from the water bath, and the trials are removed from the beaker. The trials are immediately rinsed with tap water, while rubbing the exposed enamel surface to remove any residue. The lead and cadmium release values are obtained by atomic absorption spectrophotometer, and reported as PPM.

Additional advantages and modifications will readily occur to those skilled in the art. Therefore, the invention in its broader aspects is not limited to the specific details and illustrative example shown and described herein. Accordingly, various modifications may be made without departing from the spirit or scope of the general invention concept as defined by the appended claims and their equivalents.

1. An enamel composition comprising, prior to firing:
a. 38-60 wt % SiO₂,
b. 5.1-22.9 wt % B₂O₃,
c. 8.1-18 wt % TiO₂,
d. 0.1-14.9 wt % ZnO,
e. 0.1-4.5 wt % Li₂O
f. 0.1-18 wt % K₂O, and
g. 1-7 wt % F.

2. The enamel composition of claim 1, further comprising at least one selected from the group consisting of:
a. 0.1-1.9 wt % Al₂O₃,
b. 0.1-4 wt % ZrO₂, and
c. 0.1-13 wt % Na₂O.

3. The enamel composition of claim 1, comprising:
a. 41-51 wt % SiO₂,
b. 6-17 wt % B₂O₃,
c. 8.5-13 wt % TiO₂,
d. 5.1-13 wt % ZnO,
e. 0.1-3 wt % Li₂O
f. 1-7.9 wt % K₂O, and
g. 1.5-6 wt % F.

4. The enamel composition of claim 3, further comprising at least one selected from the group consisting of:
a. 0.1-0.95 wt % Al₂O₃,
b. 0.1-1.5 wt % ZrO₂, and
c. 5-12 wt % Na₂O.

5. The enamel composition of claim 1, comprising:
a. 45-50 wt % SiO₂,
b. 8 -15 wt % B₂O₃
c. 8.5-11.5 wt % TiO₂,
d. 8-12 wt % ZnO, and
e. 0.5-2.5 wt % Li₂O
f. 1.7-4 wt % K₂O, and
g. 2-5 wt % F.

6. The enamel composition of claim 5, further comprising at least one selected from the group consisting of:
a. 0.1-0.8 wt % Al₂O₃,
b. 0.1-0.8 wt % ZrO₂, and
c. 8-11 wt % Na₂O.

7. The enamel composition of claim 1 further comprising sulfur, provided the amount does not exceed about 4 wt %, or a sufficient amount of a metallic sulfide so as to provide an amount of sulfur to the enamel composition not exceeding about 4 wt %, prior to firing.

8. The enamel composition of claim 1, further comprising at least one of: (a) 0.1-4.9 wt % Bi₂O₃, (b) 0.1-2 wt % Cs₂O, (c) 0.1-5 wt % MgO, (d) 0.1-5 wt % CeO₂, (e) 0.1-10 wt % MnO, (f) 0.1-5 wt % CuO, (g) 0.1-5 wt % NiO, (h) 0.1-10 wt % SnO, (i) 0.1-5 wt % P₂O₅, (j) 0.1-10 wt % V₂O₅, (k) 0.1-5 wt % La₂O₃, (l) 0.1-5 wt % Pr₂O₃, (m) 0.1-5 wt % Y₂O₃, (n) 0.1-5 wt % In₂O₃, (o) 0.1-10 wt % Fe₂O₃, (p) 0.1-5 wt % Cr₂O₃, (q) 0.1-5 wt % CoO, (r) 0.1-4 wt % Nb₂O₅, (s) 0.1-4 wt % WO₃, (t) 0.1-4 wt % MoO₃, and combinations thereof.

9. The enamel composition of claim 1, further comprising at least one crystalline seed material of a type selected from the group consisting of zinc borates, zinc silicates, zinc titanates, aluminum silicates, and combinations thereof.

10. The enamel composition of claim 1, wherein the composition lacks intentionally added bismuth in any form.

11. A method of decorating a substrate comprising:
a. applying to a enamel substrate a coating of an enamel composition comprising, prior to firing:
i. 38-60 wt % SiO₂,
ii. 5.1-22.9 wt % B₂O₃,
iii. 8.1-18 wt % TiO₂,
iv. 0.1-14.9 wt % ZnO,
v. 0.1-4.5 wt % Li₂O
vi. 0.1-18 wt % K₂O, and
vii. 1-7 wt % F.
b. firing the substrate and coating at a temperature sufficient to flow the enamel composition to cause the enamel composition to adhere to the substrate.

12. The method of claim 11, wherein, prior to firing, the enamel composition further comprising at least one selected from the group consisting of:
a. 0.1-1.9 wt % Al₂O₃,
b. 0.1-4 wt % ZrO₂, and
c. 0.1-13wt % Na₂O.

13. The method of claim 11, wherein the enamel composition comprises, prior to firing:
a. 41-51 wt % SiO₂,
b. 6-17 wt % B₂O₃,
c. 8.5-13 wt % TiO₂,
d. 5.1-13 wt % ZnO,
e. 0.1-3 wt % Li₂O
f. 1-7.9 wt % K₂O, and
g. 1.5-6wt % F.

14. The method of claim 13, wherein the enamel composition further comprises:
a. 0.1-0.95 wt % A₂O₃,
b. 0.1-1.5 wt % ZrO₂, and
c. 5-12 wt % Na₂O.

15. The method of claim 13, wherein the enamel composition comprisies:
a. 45-50 wt % SiO₂,
b. 8 -15 wt % B₂O₃
c. 8.5-11.5 wt % TiO₂,
d. 8-12 wt % ZnO, and
e. 0.5-2.5 wt % Li₂O
f. 1.7-4 wt % K₂O, and
g. 2-5 wt % F.

16. The method of claim 15, wherein the enamel composition further comprises:
a. 0.1-0.8 wt % Al₂O₃,
b. 0.1-0.8 wt % ZrO₂, and
c. 8-11 wt % Na₂O.

17. The method of claim 1 1, wherein the enamel composition further comprises sulfur, provided the amount does not exceed about 4 wt%, or a sufficient amount of a metallic sulfide so as to provide an amount of sulfur to the enamel composition not exceeding about 4 wt %, prior to firing.

18. The method of claim 11, wherein the enamel composition further comprises at least one selected from the group consisting of: (a) 0.1-4.9 wt % Bi₂O₃, (b) 0.1-2 wt % Cs₂O, (c) 0.1-5 wt % MgO, (d) 0.1-5 wt % CeO₂, (e) 0.1-10 wt % MnO, (f) 0.1-5 wt % CuO, (g) 0.1-5 wt % NiO, (h) 0.1-10 wt % SnO, (i) 0.1-5 wt % P₂O₅, (j) 0.1-10 wt % V₂O₅, (k) 0.1-5 wt % La₂O₃, (l) 0.1-5 wt % Pr₂O₃, (m) 0.1-5 wt % Y₂O₃, (n) 0.1-5 wt % In₂O₃, (o) 0.1-10 wt % Fe₂O₃, (p) 0.1-5 wt % Cr₂O₃, (q) 0.1-5 wt % CoO, (r) 0.1-4 wt % Nb₂O₅, (s) 0.1-4 wt % WO₃, (t) 0.1-4 wt % MoO₃, and combinations thereof.

19. An automotive enamel bearing a fired coating, the fired coating comprising, prior to firing,
a. 38-60 wt % SiO₂,
b. 5.1-22.9 wt % B₂O₃,
c. 8.1-18 wt % TiO₂,
d. 0.1-14.9 wt % ZnO,
e. 0.1-4.5 wt % Li₂O
f. 0.1-18 wt % K₂O, and
g. 1-7 wt % F.
